(19) United States
(12) Patent Application Publication
(10) Pub. No.: US 2022/0169554 A1
(43) Pub. Date: Jun. 2, 2022

(54) CONVEYING OF GLASS SHEETS BY MEANS OF CURVED ROLLERS

(71) Applicant: SAINT-GOBAIN GLASS FRANCE, COURBVOIE (FR)

(72) Inventors: Quentin DU MOULINET D'HARDEMARE, POMEYS (FR); Robert LAGNEAUX, ATTICHY (FR)

(21) Appl. No.: 17/441,100

(22) PCT Filed: Mar. 25, 2020
(86) PCT No.: PCT/EP2020/058429

§ 371 Date: Sep. 20, 2021

(30) Foreign Application Priority Data
Mar. 29, 2019 (FR) FR1903317

(51) Int. Cl. C03B 35/16; C03B 23/025; C03B 23/033; C03B 27/04; C03B 27/044

(52) U.S. Cl. CPC C03B 35/161; C03B 23/0254; C03B 27/0442; C03B 27/0404; C03B 23/033

(57) ABSTRACT

A device for conveying sheets of glass running one after another, includes at least one roller including a conveying zone for the sheets of glass, the device including actuators situated on either side of the conveying zone that are able to curve the roller in its range of elastic deformation while leaving it able to be driven in rotation about fixed centers of the sections thereof, the actuators being able to give the roller, on either side of the conveying zone, a level and a direction that give it an asymmetric shape with respect to the plane that is orthogonal thereto and situated equidistantly from the actuators.

The invention relates to a device comprising a roller for conveying and, where appropriate, bending sheets of glass, said roller being curved by forced deformation in its elastic range.

The roller according to the invention is more particularly intended to be part of a set of rollers that form a conveying bed for conveying sheets of glass running one after another. The roller (referred to as first roller) can also serve to bend sheets of glass heated to their softening point. For this kind of bending, the roller is advantageously associated with another roller (referred to as second roller) of the same type (that is to say curved by forced deformation in its elastic range) so as to form a pair of rollers between which the sheets of glass pass and are bent.

WO2005047198 discloses the bending of sheets of glass running on a shaping bed made up of rollers for advancing them, said rollers being disposed on a path with a profile in the shape of a circular arc, the sheets being bent in the advancing direction.

WO2014053776 discloses a roller for driving sheets of glass, comprising a metal rod preformed with a curved profile along its length and a flexible sheath that can turn about the rod. The shaped metal rod does not turn and it is the flexible sheath turning about said rod that turns and drives the sheets of glass.

The roller according to the invention belongs to the category of rollers curved by elastic deformation by virtue of the action of forces applied in regions of the ends thereof on either side of the conveying zone of the roller. Sheets of glass can be conveyed and, where necessary, bent by contact with this roller in the conveying zone. Generally, the curving of the roller gives it a concave curvature as seen from above or a convex curvature as seen from below. Once curved under the action of the forces applied to it, the roller can be set in rotation without its shape changing. A prior art roller belonging to this kind of roller is disclosed for example by EP413619. All of the mechanisms disclosed by EP413619 for curving the roller can be included in the scope of the present invention.

According to the prior art, the shape given to this type of roller is always symmetric with respect to its middle, and it has never been sought nor desired to modify this symmetric shape given naturally to the roller by the forces acting in the regions of its ends. This natural shape is substantially similar to a circular arc. In order to produce such a roller, use is usually made of actuators that act in regions of the two ends of the roller, these actuators being synchronized so as to act in the same way and symmetrically with respect to the middle of the roller. As a result, the roller takes on a symmetric shape with respect to its middle. The synchronization of the actuators ensures that the movement and the load imparted by one actuator on one side of the roller is followed exactly by an identical movement and load imparted by the other actuator on the other side of the roller.

The bending of sheets of glass by curving between rollers is a particularly rapid and econom ical method that is often used to produce curvatures that are simple, symmetric and shallow, such as for side windows of motor vehicle glazing units. The bending of panes of glass into more complex shapes is generally realized by different methods such as press-bending, which is otherwise much more expensive to implement.

The tolerance on the shapes of glass panes is becoming increasingly tight. It has been found that when it is sought to symmetrically bend sheets of glass running on rollers having a symmetric shape with respect to their middle, the glass finally obtained could now depart from acceptable tolerances on account of a lack of symmetry of the bend with respect to the vertical plane of symmetry passing through the middle of the rollers. This defect is attributed to a lack of uniformity in the temperature of the glass resulting from a lack of symmetry of the heating of the glass in the heating furnace used before bending. This defect also exists when it is sought to bend two sheets of glass running side by side on the bed of rollers, said two sheets being intended for example to be fitted to the two lateral sides of a motor vehicle: a difference in the bent shapes of the two sheets has been observed in spite of the simultaneous bending thereof by tools intended to give them symmetric shapes with respect to the middle of the roller. The cause of this problem is also attributed to a lack of uniformity of the heating of the two sheets passing side by side through the furnace. Finally, since the shapes of motor vehicle windows are becoming increasingly more complex, it is now also sought to produce windows that are not symmetric with respect to their conveying direction while they are being bent, using a method that is rapid and inexpensive.

The invention provides a solution to the abovementioned problems by demonstrating the possibility of producing a roller curved by forced deformation in its elastic range, said roller having an asymmetric shape with respect to a plane that is orthogonal to the roller and situated equidistantly from the actuators that force the curving of the roller. The direction in which the sheets of glass run is contained in this plane. An actuator is a piece of equipment that acts on a region of the roller outside the conveying zone of the roller so as to force the roller to take on a certain height (that is to say level) and a certain direction. An actuator can comprise at least one jack system having a moving part and a fixed part connected to the frame of the device. The movement of the moving part of the jack causes it to vertically move the end of the roller.

Thus, the invention relates to a device for conveying sheets of glass running one after another, comprising at least one roller (referred to as first roller) comprising a conveying zone for the sheets of glass, said device comprising actuators situated on either side of the conveying zone that are able to curve the roller in its range of elastic deformation while leaving it able to be driven in rotation about fixed centers of the sections thereof, the actuators being able to give the roller, on either side of the conveying zone, a level and a direction that give it an asymmetric shape with respect to the plane that is orthogonal thereto and situated equidistantly from the actuators.

The conveying zone is the zone of the roller between the actuators. The movements imparted by the actuators give the roller levels and directions such that the roller has an asymmetric shape with respect to the plane that is orthogonal to the roller and situated equidistantly from the actuators.

A roller curved elastically in a symmetric manner according to the prior art has substantially the shape of a circular arc and the plane that is orthogonal to the roller and situated equidistantly from the actuators is vertical. By contrast, a roller curved elastically in a symmetric manner according to the present invention has the shape of a comma, and
the plane that is orthogonal to the roller and situated equidistantly from the actuators can be vertical or other than vertical;
it is possible for the actuators situated on either side of the conveying zone not to be at the same height or to be at the same height, but then the directions given to the roller by the actuators are necessarily asymmetric with respect to the plane that is orthogonal to the roller and situated equidistantly from the actuators;
the actuators situated on either side of the conveying zone can give the roller directions that are symmetric with respect to the plane that is orthogonal to the roller and situated equidistantly from the actuators, but then they are not at the same height.

The actuator curves the roller reversibly since the deformation is realized in the elastic range. The roller is generally a cylinder of circular cross section. It is generally solid and made of stainless steel. Before curving, the roller is generally straight. Under the effect of its curving deformation, the axis of the roller (line passing through all the centers of the sections thereof) becomes curved.

In order for it to be possible to give a roller according to the invention an asymmetric shape, the actuators on either side of the conveying zone are preferably not synchronized, that is to say able to be actuated independently of one another. The actuator of the roller situated on one side of the conveying zone is then not synchronized with the actuator of the roller situated on the other side of the conveying zone. As described in EP413619, an actuator situated entirely on one side of the conveying zone and in the region of one end of the roller can in particular com prise:
two pairs of rolling cylinders that rotate freely, act as rolling bearings, and are situated in a staggered manner so as to be able to exert a bending moment on the roller; a first pair of rolling cylinders is located under the roller and a second pair of rolling cylinders is located above the roller; these two pairs of rollers can be spaced apart from one another in projection onto the axis of the roller by a distance of between 0.1 m and 0.5 m; the first pair is in contact with the lower part of the roller and the other pair is in contact with the upper part of the roller; this arrangement of the rolling cylinders makes it possible to apply a bending moment in the region of the end of the roller in a direction perpendicular to its axis; this moment can be applied while leaving it possible for the roller to turn freely about its axis, bearing on the two pairs of rolling cylinders,
a support arm on which the above rolling cylinders are fixed; the support arm comprising a pivot connection, the axis of which is fixed and the direction thereof substantially orthogonal to the roller;
a jack that is able to push or pull the support arm and turn the latter about its pivot connection.

The curved roller according to the invention is generally part of a bed of rollers that is able to come into contact with the sheets of glass running one after another.

The roller can thus be part of a set of substantially parallel side-by-side rollers of the same type as said roller. Thus, the bed of rollers is made up of a set of substantially parallel rollers. Thus, the device according to the invention can comprise a plurality of said roller, which are mutually parallel, forming a bed of rollers in contact with which the sheets of glass can be conveyed one after another. The bed can be a lower bed on which the sheets rest and are conveyed. The bed can also be an upper bed under which the sheets are conveyed. In the latter case, the device also comprises a lower bed and the sheets run and are generally bent between the lower bed and the upper bed. The rollers of one and the same bed are able to come into contact with a single face of the sheets of glass.

At least one actuator on at least one side of the conveying zone can simultaneously effect the curving of one or more rollers, in particular of one to four rollers. If necessary, at least one actuator on at least one side of the conveying zone can simultaneously effect the curving of at least two rollers of the bed of rollers.

The roller can serve for the thermal bending of sheets of glass. The expression thermal bending denotes the hot bending of the glass at its softening point allowing its deformation, this being permanent after it returns to ambient temperature. It is therefore not cold bending, which is applied in the elastic range of the glass. This thermal bending is carried out at a temperature greater than the glass transition temperature of the glass and generally at a temperature greater than 550° C. In particular, if the sheets are at their softening point, the sheets of glass can bend by sagging under their own weight as they run over a bed of rollers. It is also possible to form a pair of parallel rollers between which the glass is conveyed and bent as it passes between the rollers. To this end, the device can comprise a first roller according to the invention and a second roller of this type (of the same makeup as the first), these two rollers, referred to as a pair of rollers, generally having different levels (one above the other) and being mutually parallel with a constant spacing along their entire length. This spacing corresponds to the thickness of a sheet of glass, the sheets of glass being intended to pass between these two rollers.

On passing between the rollers of a pair of bending rollers, the glass is bent in a transverse direction, that is to say orthogonal to the running direction of the glass. Along this direction, the glass takes on the shape conferred by the forced curve imparted to the roller. The bending device according to the invention can also confer a longitudinal bend on the sheets of glass. To this end, it is possible to form, with juxtaposed rollers according to the invention, an upward or downward conveying bed in the form of a circular arc as seen from the side, and position, from the start of the circular arc, at least one roller of the same type (referred to as second roller) above said bed, parallel to a roller of the bed of rollers and maintaining, with said bed, a constant spacing along the entire length of the rollers, said spacing corresponding to the thickness of the sheets of glass. The device then comprises a second roller of the same type as the first roller, these two rollers, referred to as a pair of rollers, generally having different levels and being mutually parallel with a constant spacing along their entire length, the sheets of glass being intended to pass between these two rollers. As they travel along the circular arc, in addition to their transverse bend (which, according to the invention, is not a circular arc), the sheets of glass then take on the circular arc shape in the longitudinal direction. The device according to the invention may comprise air blowing nozzles that are able to blow cooling air between rollers of the same bed, in particular to carry out heat strengthening of the glass such as tempering or sem i-tempering. The nozzles can blow air between the rollers from the start of the shaping of the glass in a first portion of the circular arc path.

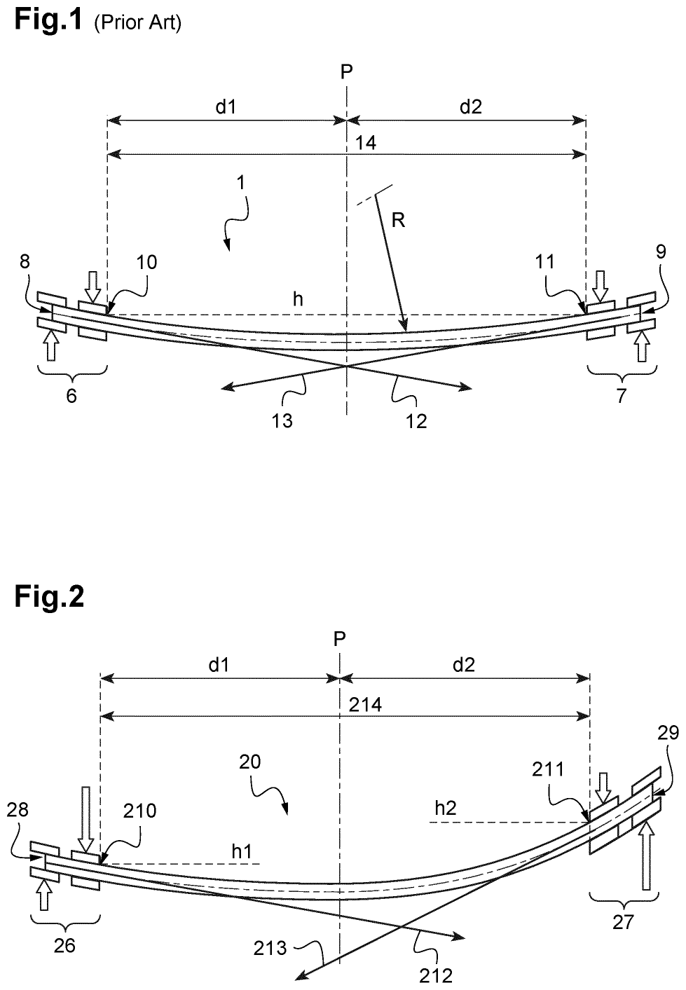

The principle of a device using two beds of rollers in the form of a circular arc as seen from the side in order to effect bending in the longitudinal conveying direction of the glass is described in particular in FIG. 2 of WO2014053776 or FIGS. 1 and 2 of WO2005047198.

Thus, the bending device according to the invention may comprise a plurality of pairs of rollers forming a bed of lower rollers and a bed of upper rollers for applying a bend to the sheets of glass passing between these two beds of rollers, said bend having at least one transverse direction perpendicular to the conveying direction of the sheets of glass. The curved shape of the rollers causes the transverse bending of the sheets. The beds of rollers can have an upward or downward curved profile in the conveying direction of the sheets of glass in order to also apply a longitudinal bend thereto. In this case, it is the upward or downward shape that causes the longitudinal bending of the sheets. In this type of configuration, all of the actuators situated on the same side of the rollers of one and the same bed are advantageously synchronized. Thus, actuators of rollers of a bed of rollers that are situated on one and the same side of the conveying zone are advantageously synchronized with one another such that the level and direction of these rollers on the side in question of the conveying zone can be controlled in a centralized manner. For example, a crank moved by an operator can actuate a chain, which for its part drives all the actuators situated on the same side of one and the same bed. It is therefore possible to have four cranks for adjusting the asymmetry of a bending device comprising for example 3 to 20 pairs of bending rollers according to the invention: a crank for actuating all the actuators on a first side of the rollers of the upper bed, a crank for actuating all the actuators on a second side of the rollers of the upper bed, a crank for actuating all the actuators on a first side of the rollers of the lower bed, a crank for actuating all the actuators on a second side of the rollers of the lower bed. Thus, actuators of rollers of the upper bed that are situated on one and the same side of the conveying zone can be synchronized with one another such that the level and direction of these rollers on the side in question of the conveying zone can be controlled in a centralized manner, and actuators of rollers of the lower bed that are situated on one and the same side of the conveying zone can be synchronized with one another such that the level and direction of these rollers on the side in question of the conveying zone can be controlled in a centralized manner.

In another variant and in order to simplify adjustments to the machine, it is also possible to synchronize the actuators of the two beds of rollers that are situated on one and the same side of the conveying zone. In this case, it may be possible to have two control systems, which can each comprise in particular a crank, for adjusting the asymmetry of a bending device comprising for example 3 to 20 pairs of bending rollers according to the invention: a control system for actuating all the actuators on a first side of the rollers of the the two, lower and upper, beds, and a control system for actuating all the actuators on a second side of the rollers of the two, lower and upper, beds. A control system may comprise a crank that is able to be actuated manually by an operator.

The roller of the device according to the invention is able to be driven in rotation by a motorized device that acts thereon between one of its ends and the actuator acting in the region of this same end. Generally, it is sufficient to drive the roller at one of its sides, its other side generally rotating freely.

The invention is useful in particular for conveying and, if necessary, bending sheets of glass with a temperature greater than 400° C., or even greater than 500° C., in particular between 400 and 700° C., and more particularly between 500 and 680° C. If the roller is intended to convey and/or bend sheets of glass at a temperature greater than 400° C., preferably, the roller is covered with a sleeve made of a material comprising refractory fibers (made of metal and/or ceramic) softening the contact with the glass.

In the context of the bending of sheets of glass, the sheets of glass are brought to their softening point by being heated in a furnace. The roller according to the invention can serve to convey and optionally bend the sheets of glass in the furnace. The bending of the sheets by virtue of the device according to the invention can be carried out after they leave the furnace, while they are still at the temperature allowing them to be bent.

The invention also relates to a method for conveying sheets of glass, comprising the conveying of sheets of glass running one after another in contact with and in the conveying zone of the roller of the device according to the invention. A plurality of sheets of glass, in particular two or four or eight sheets of glass, can be conveyed and, if necessary, bent while running side by side. Note that “side by side” means that the sheets in question come into simultaneous contact with one and the same roller. In the case of two sheets running side by side, these may be two sheets that are intended to be fitted respectively to different sides of the same motor vehicle. In particular, these two sheets of glass may be intended, upon being bent, to take on shapes that give them mirror symmetry with respect to one another (the mirror being vertical and passing through the middle of the vehicle for an observer positioned facing the front of the vehicle). In this case, the roller according to the invention is thus shaped in an asymmetric manner with respect to the plane that is orthogonal to the roller and situated equidistantly from the actuators, but with the two sheets of glass ultimately being formed so as to be symmetric with respect to one another. The asymmetry has the purpose of compensating a lack of symmetry of the heating installation. In the case of four sheets running side by side, these may be four sheets that are intended to be fitted in pairs to the two sides of the same motor vehicle. These two pairs of sheets of glass may be intended, upon being bent, to take on shapes exhibiting mirror symmetry in pairs (the mirror being vertical and passing through the middle of the vehicle for an observer positioned facing the front of the vehicle): two sheets on a first side of the motor vehicle (for example a “windshield quarter and a “front quarter”) have, corresponding to them, exactly the same glazed elements on the other side of the vehicle but in mirror symmetry with respect to those intended for the first side. On the same principle, it is also possible to bend eight sheets running side by side, in order to be fitted to one and the same vehicle, four sheets being fitted to one side of the vehicle, the other four sheets being fitted to the other side of the vehicle. These eight sheets exhibit mirror symmetry in twos, forming two groups of four sheets, all the sheets of one and the same group passing on the same side of the plane that is orthogonal to the roller and situated equidistantly from the actuators. Thus, whether two or four or eight sheets are bent side by side, the sheets of glass, upon being bent, take on shapes that give them mirror symmetries, such that each sheet passing over the roller on one side of the plane that is orthogonal to the roller and situated equidistantly from the actuators has, corresponding to it, a sheet that is symmetric thereto and passes over the roller on the other side of said plane. The sheets of glass, upon being bent, take on shapes that give them mirror symmetries, with a first sheet passing on one side of the plane that is orthogonal to the roller and situated equidistantly from the actuators having, corresponding to it, a second sheet passing on the other side of said plane, the shape of the second sheet being symmetric to that of the first sheet.

The ratio of the developed lengths of the roller on either side of the plane that is orthogonal to the roller and situated equidistantly from the actuators is generally in the range from 0.8 to 1.2.

FIG. 1 shows a prior art roller 1. Actuators 6 and 7 curve the roller in its elastic deformation range. The actuators are synchronized so as to apply symmetric movements with respect to the plane P that is orthogonal to the roller and situated equidistantly from the actuators (d1=d2). The roller is substantially in the shape of a circular arc of radius R. The actuators 6 and 7 are at the same height. The movements imparted by the actuators give the roller on either side of the conveying zone 14, at the points situated immediately outside the actuators and between the actuators (that is to say at the points 10 and 11), a level h that is identical to the right and to the left in the figure and directions 12 and 13 that are symmetric with respect to the plane P. These two directions intersect in the plane P. This roller clearly has a symmetric shape with respect to the plane P that is orthogonal to the roller and situated equidistantly from the actuators.

FIG. 2 shows a roller 20 according to the invention viewed in the longitudinal conveying direction of the sheets of glass. Actuators 26 and 27 impart movements indicated by the arrows on the roller in regions close to the ends 28, 29 thereof, on either side of the conveying zone 214, in order to curve it in its elastic deformation range. The actuators im part asymmetric movements with respect to the plane P that is orthogonal to the roller and situated equidistantly from the actuators (d1=d2). The roller is not really in the form of a circular arc but rather that of a comma. The actuators 26 and 27 are at different heights (h2>h1). The movements imparted by the actuators give the roller, at the points situated immediately outside the actuators and between the actuators (that is to say at the points 210 and 211), different levels h1 and h2 and directions 212 and 213 that are not symmetric with respect to the plane P. These two directions intersect outside the plane P. This roller has an asymmetric shape with respect to the plane P that is orthogonal to the roller and situated equidistantly from the actuators. In this case, the plane P is vertical, but this did not have to be the case.

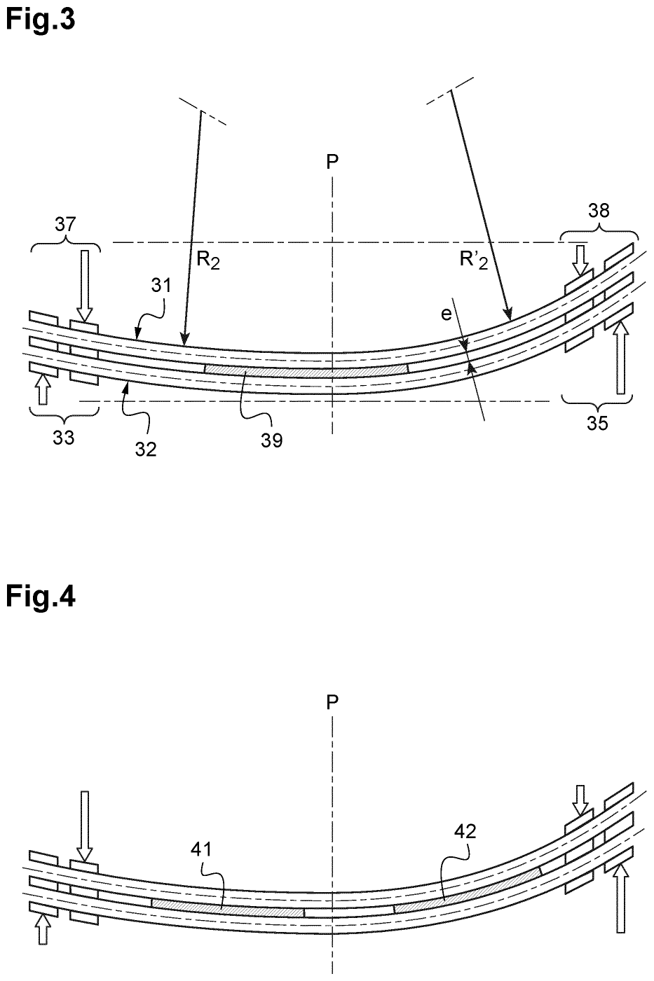

FIG. 3 shows a view in the longitudinal conveying direction of a device according to the invention com prising a pair of two rollers 31, 32 that are disposed one above the other, are mutually parallel along their entire length and at a constant distance from one another along their entire length. These two rollers have been curved asymmetrically so as to give them an asymmetric shape with respect to the plane P that is orthogonal to the roller and situated equidistantly from the actuators, like the roller in FIG. 2. The two rollers are substantially the same shape as one another but they do not exhibit the same shape on either side of the plane P. On one side of this plane (to the right in the figure), the radii of curvature R′2 are smaller than those R2 on the other side of the plane P. In this configuration, the actuators 33 and 35 act on the lower roller and the actuators 37 and 38 act on the upper roller. All of these actuators are independent (that is to say not synchronized) and an operator adjusts them in order for the spacing of the two rollers to be constant and equal to the thickness e of the sheets of glass 39 throughout the conveying zone. The sheet 39 is subjected to transverse bending, corresponding to the shape of the rollers, on passing therebetween. Synchronizing the actuators 33 and 37 with one another, for the one part, and the actuators 35 and 37 with one another, for the other part, has not been ruled out. However, it is preferable to have four actuators that are not synchronized, each one being designed to act on one end of just one roller, since this makes finer adjustment of the spacing between the rollers possible.

FIG. 4 shows the same device as the one in FIG. 3, except that it is used to simultaneously bend two sheets of glass 41 and 42 side by side that come into simultaneous contact with the rollers. It may be a pair of panes of glass, right and left, that are intended to be fitted to the two sides of one and the same motor vehicle (the difference in shape between the two sheets has been exaggerated to make it easier to understand the invention). The aim is clearly to produce two sheets with the same shapes, these shapes being mirrored with respect to one another, however, the m irror being vertical and passing through the middle of the vehicle for an observer positioned facing the front of the vehicle and looking at it. The asymmetry created by the curve of the rollers is intended to correct a heating asymmetry prior to bending so as to ultimately create sheets that are symmetric to one another.

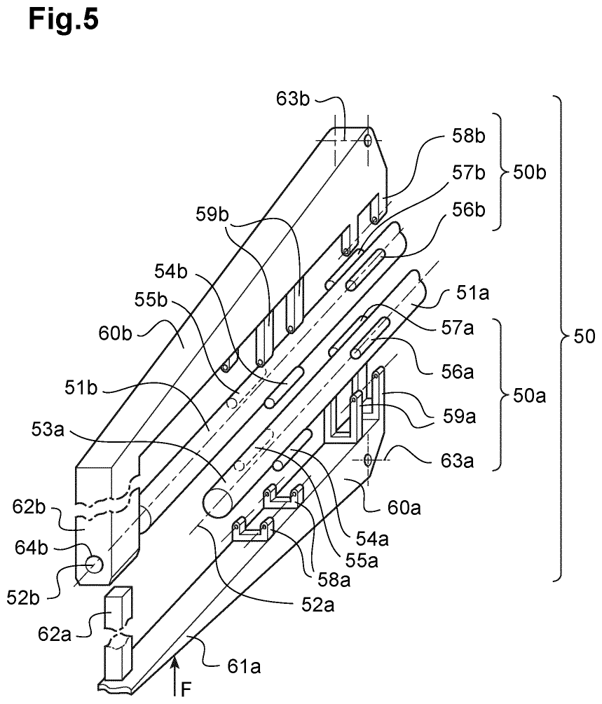

FIG. 5 is inspired by FIG. 1 of EP413619 and schematically shows a perspective view of an actuator 50 for curving a pair of bending rollers at one of their ends, it being understood that the other side of this pair of rollers is equipped with an equivalent actuator that is not synchronized with this actuator 50. This actuator 50 comprises two synchronized sub-actuators: a lower sub-actuator 50a for curving the lower roller 51a and an upper sub-actuator 50b for curving the upper roller 51b. The axes of the rollers (that is to say the curved line passing through the centers of all the sections thereof) 52a and 52b are in this case in one and the same vertical plane. When the rollers 51a and 51b are curved, their axes 52a and 52b take on the form of two parallel curves at a constant spacing along their entire length. The lower roller 51a has a free end 53a and is driven in rotation at its opposite end, not shown here. It is also guided in its terminal part by tangential supports formed by a set of two lower rolling cylinders 54a and 55a and a set of upper rolling cylinders 56a and 57a. These four rolling cylinders act as a rolling bearing for rollers. They are mounted on forks 58a and 59a so as to be mounted in a manner allowing them to rotate freely. These forks are fixed to a support arm 60a that can pivot about the axis 63a. The upper roller 51b is mounted vertically above the lower roller 51a and is similarly guided by the rolling cylinders 54b, 55b, 56b, 57b. The rolling cylinders guiding the roller 51b are positioned exactly vertically above the rolling cylinders guiding the lower roller 51a. These rolling cylinders are mounted on forks 58b and 59b fixed to a second support arm 60b pivoting about the axis 63b. The support arm 60a also carries a stop 62a that faces the stop 62b carried by the upper arm 60b. The stop 62b additionally has a passage 64b for the elements for driving the roller 51b in rotation.

The device schematically depicted in FIG. 5 has, corresponding to it, a perfectly symmetric device positioned on the other side (not visible in the figure) of the rollers 51a and 52b. If a movement is imparted on the free end 61a of the arm 60a along the direction of the arrow F, the angular movement of the arm is brought about, which pivots about the axis 63a. By way of the stops 62a and 62b, this force is transmitted directly to the arm 60b. In this way, perfectly identical bending of the rollers 51a and 51b is achieved. The bend adopted by the rollers depends directly on the vertical position of the arms 60a and 60b, it being possible for this position to be modified easily by a mechanical jack or a cam.

The system of stops 62a and 62b thus makes it possible to couple the sub-actuators 50a of the lower roller and 50b of the upper roller. The two rollers are thus curved simultaneously by a single movement being imparted on the actuator 50a.

As mentioned above, the actuator 50 is generally associated with another actuator of the same type 50′ (not shown here) that is situated at the other end of the rollers 51a and 51b, on the other side of the conveying zone. In this case, the asymmetry of bending of the rollers originates from the fact that each actuator 50 and 50′ imparts a different direction on each end of the pair of rollers 51a and 51b.

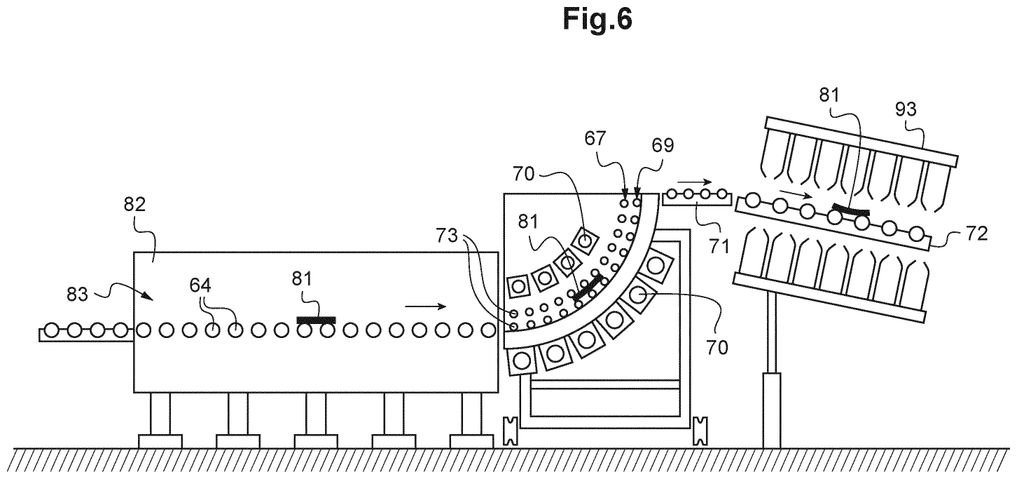

The pairs of forming rollers mounted as schematically depicted in FIG. 5 are advantageously used to form a conveyor, the path of which has a curved profile, with the concavity thereof preferably facing upward. A forming and tempering machine having such a conveyor is schematically depicted in FIG. 6.

FIG. 6 is a schematic depiction in side view (transverse view) of a bending and tempering machine to which the invention more particularly applies. A sheet of glass runs through and is heated in a furnace, then passes between two upward beds of rollers that form a shaping assembly, and then, at the outlet, through a secondary cooling zone. The sheet of glass 81, which is initially flat, firstly crosses a heating zone 82 of a tunnel furnace (the arrow in the furnace indicates the conveying direction, which is also the longitudinal direction), through which it is carried on a horizontal conveyor 83 moved by a bed of straight motorized rollers 64 that are aligned in a plane. At the outlet of the temperature-raising furnace, the glass is at its deformation temperature, allowing the thermal bending thereof. The sheet of glass 81 then passes into a shaping zone comprising a bed of upper rollers 67 and a bed of lower rollers 69 that are mounted with an upward curved profile in the form of a circular arc in side view. The running sheets of glass are squeezed and shaped between pairs 73 of rollers of these two beds of rollers. It can be seen that the rollers of a pair of rollers generally have different levels, one generally being higher than the other, except perhaps for the last pair of rollers, in which the rollers are substantially at the same height. The bed of rollers 67 and the bed of rollers 69 thus form an upward shaping assembly with an upwardly curved profile. The sheets of glass 81 are bent, starting at the first pairs 73 of rollers, in the transverse direction as shown in FIG. 3, and in the longitudinal direction corresponding to the upward circular arc shape of the beds of rollers. This shaping is followed by cooling between the two beds of rollers, in particular tempering. To this end, nozzles blow cool air between the rollers onto the two faces of the sheets. These nozzles are connected to box structures 70 that supply them with the necessary air. The glass is thus fixed just after it has been bent. The air is blown starting at the first pairs of bending rollers 73. On leaving the shaping and tempering assembly, the sheets of glass tip onto a conveyor 71. The sheets of glass 81 are then evacuated by a flat conveyor 72 that passes through a secondary cooling zone 93.

1. A device for conveying sheets of glass running one after another, comprising a first roller, comprising a conveying zone for the sheets of glass, said device comprising actuators situated on either side of the conveying zone that are configured to curve said first roller in its range of elastic deformation while leaving it able to be driven in rotation about fixed centers of sections thereof, the actuators being configured to give said first roller, on either side of the conveying zone, a level and a direction that give it an asymmetric shape with respect to a plane that is orthogonal thereto and situated equidistantly from the actuators.

2. The device as claimed in claim 1, wherein a first of the actuators of said first roller that is situated on one side of the conveying zone is not synchronized with a second of the actuators of said first roller that is situated on the other side of the conveying zone.

3. The device as claimed in claim 1, comprising a plurality of said first rollers, which are mutually parallel and form a bed of rollers in contact with which the sheets of glass are conveyed one after another.

4. The device as claimed in claim 3, wherein at least one actuator on at least one side of the conveying zone is configured to simultaneously curve at least two rollers of the bed of rollers.

5. The device as claimed in claim 1, comprising a second roller of the same type as the first roller, the first and second rollers forming a pair of rollers, being mutually parallel with a constant spacing along their entire length, the sheets of glass being to pass between the first and second rollers.

6. The device as claimed in claim 5, comprising a plurality of pairs of rollers forming a bed of lower rollers and a bed of upper rollers for applying a bend to the sheets of glass passing between the beds of lower and upper rollers, said bend having at least one transverse direction perpendicular to a conveying direction of the sheets of glass.

7. The device as claimed in claim 6, wherein the beds of lower and upper rollers have an upward or downward curved profile in the conveying direction of the sheets of glass in order to also apply a longitudinal bend to the sheets of glass.

8. The device as claimed in claim 3, further comprising air blowing nozzles that are configured to blow air between rollers of the same bed.

9. The device as claimed in claim 3, wherein actuators of rollers of a bed of rollers that are situated on one and the same side of the conveying zone are synchronized with one another such that a level and direction of the rollers on said side of the conveying zone are controllable in a centralized manner.

10. The device as claimed in claim 6, wherein actuators of rollers of the upper bed that are situated on one and the same first side of the conveying zone are synchronized with one another such that a level and direction of the rollers on the first side of the conveying zone are controllable in a centralized manner, and actuators of rollers of the lower bed that are situated on one and the same second side of the conveying zone are synchronized with one another such that a level and direction of the rollers on the second side of the conveying zone are controllable in a centralized manner.

11. A method for conveying sheets of glass, comprising conveying sheets of glass running one after another in contact with and in the conveying zone of the first roller of the device of claim 1, said first roller having an asymmetric shape with respect to the plane that is orthogonal to said first roller and situated equidistantly from the actuators.

12. The method as claimed in claim 11, wherein a plurality of sheets of glass are conveyed side by side.

13. The method as claimed in claim 11 wherein said device comprises a second roller of the same type as the first roller, the first and second rollers forming a pair of rollers, being mutually parallel with a constant spacing along their entire length, the sheets of glass passing between the first and second rollers, said device comprising a plurality of pairs of rollers forming a bed of lower rollers and a bed of upper rollers, the sheets of glass undergoing a bend on passing between the beds of lower and upper rollers, said bend having at least one transverse direction perpendicular to a conveying direction of the sheets of glass.

14. The method as claimed in claim 13, wherein the beds of lower and upper rollers have an upward or downward curved profile in the conveying direction of the sheets of glass, the sheets of glass also being bent in a longitudinal direction on passing between the lower and upper beds of rollers.

15. The method as claimed in claim 13, wherein two or four or eight sheets of glass are bent simultaneously side by side.

16. The method as claimed in claim 15, wherein the sheets of glass, upon being bent, take on shapes that give them mirror symmetries, with a first sheet passing on one side of the plane that is orthogonal to the roller and situated equidistantly from the actuators having, corresponding to it, a second sheet passing on the other side of said plane, the shape of the second sheet being symmetric to that of the first sheet.

17. The method as claimed in claim 14, wherein, after bending, air is blown onto the glass between rollers of one and the same bed in order to thermally strengthen the glass.

18. The device as claimed in claim 8, wherein the air blowing nozzles are configured to blow air to carry out heat strengthening of the glass.

19. The method as claimed in claim 17, wherein, after bending, air is blown onto the glass between rollers of one and the same bed in order to thermally temper it.
